(19) United States
(12) Patent Application Publication
(10) Pub. No.: US 2009/0117376 A1
(43) Pub. Date: May 7, 2009

(54) Apparatus and Method for the Production of Corrugated and Laminated Board and Compositions Based Thereon

(75) Inventors: Steven Bloembergen, Okemos, MI (US); Erik Strom, Springfield, MA (US); Robert H. Nebeling, Wayne, NJ (US)

Correspondence Address: QUARLES & BRADY LLP, 411 E. WISCONSIN AVENUE, SUITE 2040, MILWAUKEE, WI, 53202-4497, US

(73) Assignee: ECOSYNTHETIX INC., Lansing, MI (US)

(21) Appl. No.: 11/815,600

(22) PCT Filed: Feb. 10, 2006
(86) PCT No.: PCT/US06/04968

§ 371 Date: Sep. 16, 2008

Related U.S. Application Data
(60) Provisional application No. 60/651,855, filed on Feb. 10, 2005.

(51) Int. Cl. B32B 27/04

(52) U.S. Cl. 428/341; 156/64; 156/378

(57) ABSTRACT

The invention relates to an application system for water-based adhesives to produce corrugated and laminated board products using less adhesive than traditionally possible. The water based colloidal adhesive is selected from the group consisting of biopolymer nanoparticles and formulations based thereon, polyvinyl acetate and formulations based thereon, polyvinyl alcohol blends and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

### CROSS-REFERENCES TO RELATED APPLICATIONS

The application claims benefit from U.S. Provisional Patent Application No. 60/651,855 filed Feb. 10, 2005.

### STATEMENT REGARDING FEDERALLY SPONSORED RESEARCH

Not Applicable.

### BACKGROUND OF THE INVENTION

1. Field of the Invention

The present invention relates to a method and apparatus for applying water-based adhesives to produce corrugated and laminated board products using less adhesive than traditionally possible.

2. Description of the Related Art

Referring to FIG. 1A, a single face corrugated board (or web) 20 typically includes a relatively porous paper substrate (referred to herein as a medium 21). A corrugated (fluted) profile 23 is imparted onto medium 21, and a liner 24 is applied to an outer surface of the medium 21 via an adhesive (not shown). The fluted profile 23 has opposing outer ends 25 (also referred to herein as flute tips).

Referring to FIG. 2, the corrugating process is carried out by passing medium 21 through a corrugator 28 including intermeshed corrugated rolls (not shown), typically stationed in a single facer glue station 27, that imparts the fluted profile 23 to the medium 21. The medium 21 passes through one or more single facer glue stations 27 that apply an adhesive (not shown) and liner 24 to one side of the medium 21 to form single face web 20 (see FIG. 1A). The liner 24 can, for instance, be in the form of treated and untreated paper. The single face web 20 then travels to a bridge 30 upon which it festoons and is transported to a double facer glue station 32. The components illustrated in FIG. 2 are well-understood by one having ordinary skill in the art.

Referring specifically to FIG. 3A, double facer glue station 32 includes a glue pan 34 that receives liquid adhesive 35 via a glue inlet manifold 36, and delivers excess glue to a glue outlet 38. The adhesive 35 thus travels generally in a direction from inlet 36 to outlet 38. The glue inlet manifold 36 and glue outlet 38 are separated from the glue pan 34 via an inlet weir 40 and an outlet weir 42, respectively. A glue applicator roll 44 includes a lower portion 46 that receives adhesive 35 from the glue pan 34. Roll 44 rotates in the direction indicated by Arrow A such that the adhesive 35 (which travels opposite to the direction of travel of the lower applicator roll surface) is coated onto the outer surface of the roll 44 as a layer 37. A metering roll 48 rotates in the direction of Arrow B (the same direction as roll 44) in close proximity to the applicator roll 44. A gap 50 separates the rolls 44 and 48, and affects the thickness of adhesive remaining layer 37 on the portion of applicator roll 44 that has traveled past metering roll 48 (i.e., downstream of gap 50).

Conventional rolls are produced whose outer surfaces have patterns up to 45 lines per inch (LPI), to even fined sandblasted surface, implemented for lower viscosity (typically <500 cps) starch corrugating adhesives in order to prevent slinging. “Slinging” occurs when the adhesive travels through the gap 50 and fails to adhere to the outer surface of roll 44.

The single face web 20 is fed to the application roll 44 along the direction of Arrow C, and is biased against roll 44 under pressure provided by a pressure bar 51. It should be appreciated that the direction of single face travel is essentially parallel to the travel of roll 44 at the location of contact between single face web 20 and roll 44. The adhesive layer 37 is delivered from roll 44 onto the flute tips 25 of the single face web 20. A blade 52 scrapes adhesive off the metering roll 48 that has been received from roll 44.

Typically, the applicator roll 44 is driven by an electrical or mechanical drive (not shown), which is linked to the metering roll 48 via a mechanical linkage, such as gears, a belt and pulley system, or sprockets and chains (not shown), that runs at a set speed ratio relative to the applicator roll 44 (generally about 70%). The metering roll 48 can also be driven by a separate electrical drive for which the speed ratio is adjustable, but in practice these generally follow the glue applicator roll 44 at a preset set speed ratio typically of about 70%, but this may range from about 40% to 80%.

By subsequently adding adhesive to flute tips of the medium 21 on the side that remains unglued after passing through single facer glue station 27, the additional layer of liner 26 can be adhered onto the single face to produce a double face board 20′ (FIG. 1B), resulting in the production of combined corrugated board. As used herein, the term “combined” refers to a product (including, single and multiple wall corrugated boards) whereby a liner is adhered to both outer sides of the medium. The double-face board 20′ is then transported to a heating station 54, which typically includes hot plates or steam heated rolls, to produce sufficient heat transfer to set and dry the adhesive in the double facer operation. The combined board 20′ is then transferred to a slitter section 56 that produces cut sheets of corrugated board from the double-faced web. The corrugated board 20′ is then delivered to a stacker 58 and moved to storage, further processing, or shipment.

Referring again to FIG. 1B, because the corrugated board 20′ is fabricated from a single medium 21, the corrugated board 20′ can be referred to as a “single wall” corrugated board. It should be appreciated, however, that many variations exist for corrugated board construction. For example, a multi-wall board (for instance the double wall board 20″ illustrated in FIG. 1C and the triple wall board 20′″ illustrated in FIG. 1D) is produced in the same general manner as described above by combining successive single face webs to each other, followed by a final application of a liner.

The adhesive used in corrugating plays an important role in the quality and production efficiency of single and multiple wall corrugated boards. A more detailed description of corrugating and corrugating adhesives can be found in “The Corrugator”, A. H. Bessen, Jelmar Publishing Co., Inc., 1999, and in “Preparation of Corrugating Adhesives”, W. O. Koeschell, Ed., Technical Association of the Pulp and Paper Industry, Inc., 1977.

The manufacture of corrugated board 20′ generally uses water-based adhesives prepared in a number of ways, the most common of which are Stein Hall type starch adhesives. These adhesives are not high solids colloidal dispersions, but rather are low solids aqueous suspensions of native starch granules. These suspensions of starch, in which the granules remain intact and typically average about 30 to 50 mm (=0.0012 to 0.0020 inches, or 12-20 mils) in size, are commonly used at a total dry solids level of about 22 to 26%. They are sometimes boosted to 30% or slightly higher using low molecular weight specialty starches and other additives. These solids numbers are on a “bone dry” basis, i.e. the total dry solids content. It is quite common for the corrugating industry to express the % solids for adhesives on an “industrial” basis, which is calculated based on moist starch (thus ignoring the original moisture in the starch). Given starch typically includes about 12% moisture, 30% solids on an industrial basis equates to about 26% of actual solids on a bone dry basis.

The original implementation of cooking starch, in the early 1900's, consisted of using a starch adhesive where high temperatures are used to form the bond after the adhesive film has been applied. This starch adhesive principle is based on the suspension of raw, uncooked starch by a cooked starch carrier. The carrier provides sufficient viscosity or body to suspend the starch granules and to facilitate deposition of the adhesive film on the corrugated flutes. As the combined board is subjected to high heat of the corrugating operation, the uncooked starch on the adhesive line gelatinizes to form the adhesive bond. Today this is still the dominant technology for corrugated board manufacturing. Thus the speed of a corrugator is limited by its ability to transfer heat to the glue line between the layers of paperboard. Given that paper is a good insulator, a substantial amount of heat is necessary to enable the double facer adhesive line to reach its gel point for multi-wall board. The corrugator is therefore required to run relatively slowly when producing multi-wall board.

Traditional starch adhesives used in today's corrugating operations are generally prepared according to plant-standardized recipes in a starch kitchen. These recipes typically consist of two types of starch mixes: 1) the Stein Hall type which contains a cooked carrier starch (typically ˜5-25% of the total starch) and an uncooked slurry of starch granules, and 2) a no-carrier system in which all of the granular starch is partially precooked or pre-gelatinized (Peter A. Snyder, Corrugating International, Vol. 2, No. 4, October 2000, pp. 175-179). Caustic soda and borax are both added to modify the gel temperature and final properties of the starch adhesive preparation. Upon addition to the corrugated board in the corrugating operation, the adhesive is further heated to the point at which the starch granules are converted into adhesive starch, the remaining water is evaporated and the final dry bond is formed in the corrugated board. The starch granules become an effective adhesive only when they reach a sufficiently high temperature (the gel point) in the corrugating process.

It is well known that many of the quality problems associated with corrugated board manufacturing are associated with the adhesive and its application. For instance, poor or non-uniform adhesives can result in substandard product. If too little adhesive is applied, the corrugated board produced is generally substandard and must be discarded, thus decreasing the efficiency of the corrugating operation. Therefore, given the usual process fluctuations, more adhesive is generally applied than what is required, especially considering that the total cost of the paper far exceeds that of the adhesive. The adhesive application on conventional commercial corrugators at the double facer section is generally heavy, and typically ranges from about 1.2 to 2.5 lb/msf (pounds per thousand square foot on a dry adhesive basis) C-flute equivalent of dry adhesive, due to the design of the glue application system. Unfortunately, excessive adhesive requires additional time to ensure that the adhesive is heated to the gel point required to produce reliable dry bond in the final product, thus resulting in a reduced throughput through the corrugator.

An additional quality problem associated with corrugated board manufacturing results from the adhesive containing 70 to 80% water, thus limiting the maximum speed of the corrugator by the length of the double facer heating station 54 at the end of the corrugating operation. Furthermore, the resultant board can often be of relatively poor quality due to excess water in the adhesive that remains after heating.

By raising the solids content of the adhesive, less water will need to be removed to dry the corrugated board. Accordingly, the energy consumed in maintaining heating section 54 at the desired temperature (typically about 350° F. in order to sufficiently heat the corrugated board 20′) will be reduced. However, if the solid content is too high in conventional starch corrugating adhesives, high product viscosities and premature drying of the adhesive can result, leading to insufficient conversion of the slurry part of the starch into adhesive starch. This will reduce the quality of the final product. This pre-mature drying is a particular problem for conventional starch corrugating adhesives because, if there is not enough water, gelation cannot occur. Therefore, the use of high solids colloidal adhesives in corrugating is novel and advantageous, because their use eliminates the need for high temperatures normally required to convert the starch slurry in conventional starch corrugating adhesives.

Unfortunately, referring to FIG. 3B, the present inventors have discovered that, when adhesive 35 has a high viscosity (for example, approximately 1000 to 3000 cps (centipoise)), the ability of the adhesive to flow through the pan towards the drain is limited. As a result, the adhesive liquid level rises in the pan 34, filling the region (nip 60) located in close proximity to the gap between the glue applicator roll 44 and metering roll 48. Consequently, adhesive floods the nip 60 (i.e., the nip 60 is occupied by adhesive from pan 34) prior entering the gap 50, and an increased level of adhesive travels through the gap 50 to yield an increase in wet glue film thickness 37 on the applicator roll 44 that is subsequently delivered to the flute tips of the single face web 20. The flooded nip phenomenon is further described in Coyle, D. J, C. W. Macosko and L. E. Scriven, “Reverse Roller Coating of non-Newtonian liquids”, J. Rheology, 34, p. 615, 1990.

Yet another quality problem associated with corrugated board manufacturing results from limitations in the ability to control the amount of adhesive applied with the conventional application equipment used in commercial corrugating operations. Generally, the amount of adhesive applied is controlled by the thickness of the gap 50 between the applicator roll 44 and metering roll 48. Under ideal conditions, for adhesive application equipment that has been carefully spaced, built, aligned and tested, the minimum gap setting generally is 0.004±0.001 inch (˜100±25 μm). It should be appreciated that the length of the applicator and metering rolls is generally quite long (up to 110 inches and spanning the width of the corrugated line), and with the best machining possible, the rolls can be manufactured with a total run-out (TIR), or “deviation from the roundness of the rolls,” of approximately ±0.001 inch. Given that commercial starch corrugating adhesives contain starch granules that range in diameter up to about 0.002 inch (˜50 μm), a gap of less than 0.004 inches would cause partial blockage and non-uniform transfer of adhesive, even if there was zero play in the bearings. Therefore, the more commonly used gap settings in commercial corrugating operations range from 0.006 to 0.012 inches (=6 to 12 mils, or ˜150 to 300 μm).

A typical range of adhesive application in the double facer operation of a corrugator is between 1.2 to 2.5 lb/msf C-flute equivalent for single wall board construction. The term “C-flute equivalent” is used to facilitate the comparison of many different aspects of the corrugated board manufacturing process to different flute sizes that are used in the industry. Common flute sizes include the larger K, A, C and B flutes, as well as the smaller microflutes including E, F, G, N (listed in order of decreasing flute size) and other microflutes. Note that the term “C-flute equivalent” is commonly used by corrugated board manufacturers to develop a simple method of comparing adhesive cost for combined board of different flute types. It is not a highly accurate measure of application, especially for the smaller flute sizes, and therefore it is not commonly used in the laminating industry.

Advantageously, the truss-like structure of the fluted medium 21, sandwiched between the liners, imparts superior strength to the corrugated board 20′ and the resulting corrugated box.

Laminated board typically is produced through a process similar to that of producing corrugated board. However, in contrast to the corrugating process described above, most laminating processes do not use the same starch adhesives.

The different types of laminating processes include in-line laminating (single face to liner), sheet-fed laminating (single face to liner), solid fiber laminating (liner to liner), dual arch laminating (medium to medium), bulk box laminating (combined corrugated board to corrugated board), label laminating (label to liner), and other laminating processes. In this regard, it should be appreciated that the term “substrate” is used herein to broadly refer to any object that can be laminated in either a corrugator or during a laminating process.

The in-line laminating process is the dominant process, and accounts for the majority of laminated board produced in the marketplace. It is similar to corrugating in producing the single face, but differs in its double facer operation. For example, in-line laminating produces, among other products, the type of colorful packaging that displays “point-of-sale” information on the outside of the box in high quality graphics printing (e.g. for electronics, toys, etc.). In order to protect the high color graphics, the gluing process is carried out at ambient temperatures, as opposed to the double facer in corrugating where the hot plates section is at about 350° F. As noted above, this heat in the corrugating process is required to gel the starch adhesive. Therefore, the conventional starch adhesive used in corrugating cannot be used in laminating.

Instead, other water-based adhesives are used in laminating, including water soluble adhesives and polymer colloids. Water solubles include formulations of polyvinyl alcohol (PVOH), dextrins (broad molecular weight oligomeric mixtures produced by degradation of starch), and other water soluble polymers. Synthetic, petroleum based adhesives have dominated the laminating industry. Most commonly these are high-solids water based dispersions of polymer colloids, which contain particles with an average size range of less than 1 μm (<0.00004 inch or <0.04 mil). The most common type of adhesive used is a polyvinyl acetate (PVA) “white glue”, which generally consists of a water based formulation at about 45 to 60% solids (note that the % solids is expressed on a “bone dry” basis), but in principle can be as high as the theoretical maximum of 72% solids. The industry trend has been to move to higher solids levels with this type of glue to achieve higher line speeds.

However, the control over the delivery of the adhesive on the application equipment is limited, and more adhesive is generally being applied than is required to form the bond. Using wet film thicknesses of up to 20 mils (0.020 inch), the amount of dry adhesive applied in the laminating industry can be as high as 6 lb/msf or even higher, per applied adhesive layer on the laminated sheet side of the combined board. Therefore, there is a need to reduce glue consumption, in part because the industry is aware that more adhesive is being used than necessary to form the bond, but more recently because of the industry wide move toward smaller flute sizes. Smaller flutes result in a greater number of glue lines, thus exacerbating the high amounts of glue applied. As a result, even more water is introduced into the paper board product. Given that the process is conducted at ambient temperatures, this over-application of adhesive leads to slower line speeds and warped and wet products. This leads to long drying times between the laminator and the next operations (such as die cutting, etc.), which can range from 8 to 24 hours depending on the type of substrates used, thus leading to process inefficiencies.

In an effort to combat these problems, a number of laminators have moved to the use of foaming equipment that introduces small air bubbles into the glue to reduce the overall amount of glue applied by about 10 to 40%. As a result of such foamers, the typical range of dry adhesive currently being applied in a number of laminating operations can therefore be as low as about 2 to 3 lbs/msf on the laminated sheet side of the board. A surfactant is generally added to the adhesive in support of such foaming operations, which unfortunately tends to weaken the adhesive bond, thus limiting the potential for further reduction of adhesive application.

What is therefore needed is a method and apparatus for reducing the thickness of the adhesive applied to a roll that is subsequently delivered when fabricating corrugated and laminated products without detracting from the quality of the final product.

### SUMMARY OF THE INVENTION

In accordance with the present invention, an adhesive application system in corrugated board and laminated board manufacturing has been designed to coat a thinner film of a water-based adhesive at a lower coat weight than traditionally possible.

In one aspect, the invention provides a method of applying a water-based adhesive to a substrate in an apparatus including a metering device, an applicator roll receiving at its outer surface the water-based adhesive and delivering a layer of the water-based adhesive to the substrate. In the method, the delivered layer is applied at a coat weight less than 1.2 pounds/msf/layer based on dry weight per layer of adhesive applied. The water-based adhesive may be selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former. The biopolymer nanoparticles may be particles of a cross-linked starch or a cross-linked starch derivative characterized by an average particle size of less than 400 nanometers. The substrate may be a fluted single face medium, and the water-based adhesive may be applied onto flute tips of the medium at a wet solids level up to 72% (wt/wt).

In the method, the apparatus may further include a glue pan that circulates the adhesive, and the adhesive in the glue pan may be forced in a direction substantially parallel to a location on the applicator roll that receives the adhesive. The metering device may be a metering roll, and the method may further involve preventing the adhesive from pooling in a nip region disposed between the metering roll and the applicator roll. Also, the method may involve rotating the metering roll at a speed between 100% and 120% of a speed at which the applicator roll is rotated. Optionally, the applicator roll is engraved with a pattern of less than 20 lines per inch. The substrate may travel at a speed between 98% and 102% of a speed of a portion of the applicator roll that interfaces with the substrate. In one form, the wet adhesive layer has a thickness less than 0.005 inches. Alternatively, the metering device is a scraper.

In another aspect, the invention provides a glue station configured to apply a water-based adhesive to a substrate. The glue station includes a rotating applicator roll for receiving the adhesive, a metering device spaced from the applicator roll by a gap that meters the thickness of a layer of the adhesive on the applicator roll, and a substrate delivery system for delivering the substrate to a location proximal the applicator roll. The substrate receives the layer in an amount less than 1.2 pounds/msf/layer based on dry weight per layer of adhesive applied. The water-based adhesive may be selected from the adhesives useful in the method of the invention described above.

In the glue station of the invention, the substrate may be a fluted single face medium, and the water-based adhesive may be applied onto flute tips of the medium at a wet solids level up to 72% (wt/wt). The applicator roll may receive a layer of the adhesive from a glue pan retaining the water-based adhesive. Preferably, the adhesive travels in the glue pan in a direction substantially parallel to a location on the applicator roll that receives the adhesive. The metering device may be a rotating metering roll. In one feature of the glue station, the adhesive does not pool in a nip region disposed between the metering roll and the applicator roll. The metering roll preferably rotates at a speed substantially equal to between 100% and 120% of a speed at which the applicator roll is rotated, and the substrate travels at a speed between 98% and 102% of a speed of a portion of the applicator roll that interfaces with the substrate. Optionally, the applicator roll is engraved with a pattern of less than 20 lines per inch. The wet adhesive layer may have a thickness less than 0.005 inches. In one form, the metering device comprises a scraper.

In yet another aspect, the invention provides a corrugated board construction wherein a single face medium is adhered to a liner by a water-based adhesive applied at a dry solids coat weight of less than 1.2 lb/msf C-flute equivalent per layer of double facer glue lines, the number of the layers being one for single wall board construction, two for double wall board construction, and three for triple wall board construction, and at a glue application rate proportional to the number of layers of double facer glue lines. The water-based adhesive may be selected from the adhesives useful in the method of the invention described above.

In still other aspects, the invention provide methods for producing laminated board. The method may include the step of applying a water-based adhesive to the flute tips of a substrate comprising a single face medium at a lower coat weight than traditionally possible. The method may include the step of applying a water-based adhesive to a substrate comprising one or more liners at a lower coat weight than traditionally possible. The method may include the step of applying a water-based adhesive to a substrate comprising one or more mediums at a lower coat weight than traditionally possible. The method may include the step of applying a water-based adhesive to a substrate comprising a liner of one or more combined corrugated boards at a lower coat weight than traditionally possible. The method may include the step of applying a water-based adhesive to a substrate comprising a label at a lower coat weight than traditionally possible.

In the above methods for producing laminated board, the water-based adhesive may be selected from the adhesives useful in the method of the invention described above. The water-based adhesive may be applied at a wet solids level up to 72% (wt/wt) to result in an applied dry solids coat weight of less than 2.0 lb/msf per applied adhesive layer. The water-based adhesive may be applied as a thin coating by avoiding a wiping action and ensuring that the substrate and a glue applicator roll are running at close to the same speeds. Also, the water-based adhesive may be applied as a thin coating by maintaining the glue applicator roll to substrate speed ratio between 98 to 102%. Also, the water-based adhesive may be applied as a thin coating by adjusting a metering roll to applicator roll speed ratio to obtain the lowest possible wet film thickness on the applicator roll. The water-based adhesive may be applied as a thin coating by replacing a metering roll with an adjustable scraper blade to meter the amount of adhesive on the roll. Also, the water-based adhesive may be applied as a thin coating by adjusting the height of a rider roll to ensure that the flute tips dip only into a fraction of the wet adhesive film. In one example method, a wet adhesive coating less than 0.005 inches is applied.

In still another aspect, the invention provides a laminated board construction wherein a single face medium is adhered to liner by a water-based adhesive applied at a dry solids coat weight of less than 2.0 lb/msf. The laminated board construction may include one or more liners adhered by a water-based adhesive applied at a dry solids coat weight of less than 2.0 lb/msf per applied layer of adhesive. The laminated board construction may include one or more mediums adhered by a water-based adhesive applied at a dry solids coat weight of less than 2.0 lb/msf per applied layer of adhesive. The laminated board construction may include one or more combined corrugated boards adhered by a water-based adhesive applied at a dry solids coat weight of less than 2.0 lb/msf per applied layer of adhesive. The laminated board construction may include one or more labels adhered by a water-based adhesive applied at a dry solids coat weight of less than 2.0 lb/msf per applied layer of adhesive. The water-based adhesive may be selected from the adhesives useful in the method of the invention described above.

In the methods of the invention, an increase in the solids level of the water-based adhesive up to 72% (wt/wt) leads to a shortening of the curing time between production of the combined board and subsequent operations. Also, an increase in the solids level of the water-based adhesive up to 72% (wt/wt) leads to improved productivity and reduced warp, shrinkage, adhesive consumption, energy consumption, and overall cost of manufacturing. Furthermore, the reduction in the amount of water-based adhesive applied leads to a shortening of the curing time between production of the combined board and subsequent operations. Also, the reduction in the amount of water-based adhesive applied leads to improved productivity and reduced warp, shrinkage, adhesive consumption, energy consumption, and overall cost of manufacturing. Preferably, the % solids of the water-based adhesive is less than 50% in order to further decrease the dry coat weight of adhesive in the resultant product. Most preferably, the % solids of the water-based adhesive ranges from 35% to 40% in order to further decrease the dry coat weight of adhesive in the resultant product.

Other aspects and advantages will become apparent, and a fuller appreciation of specific adaptations, compositional variations, and physical attributes will be gained upon an examination of the following detailed description of the various embodiments, taken in conjunction with the appended claims.

### BRIEF DESCRIPTION OF THE DRAWINGS

FIG. 1A is a perspective view of a single face corrugated board.

FIG. 1B is a perspective view of a single wall corrugated board.

FIG. 1C is a perspective view of a double-wall corrugated board.

FIG. 1D is a perspective view of a triple-wall corrugated board.

FIG. 2 is a schematic illustration of a corrugating system.

FIG. 3A is a schematic illustration providing one example of a conventional double facer glue station used in the corrugating system illustrated in FIG. 2.

FIG. 3B is a schematic illustration of the glue station illustrated in FIG. 3A with a flooded nip region.

FIG. 4A is a schematic illustration of a glue station constructed in accordance with certain aspects of the present invention.

FIG. 4B is a schematic illustration of the glue station illustrated in FIG. 4A showing an adhesive circulation system.

FIG. 4C is a schematic illustration of a glue station constructed in accordance with an alternative embodiment of the present invention.

FIG. 5 is a schematic illustration providing one example of a conventional in-line laminator.

FIG. 6A is a graph plotting pin adhesion as a function of time for a plurality of adhesives used on a substrate having a B-Flute profile in a laminating system. In particular, FIG. 6A shows laminating performance of two commercial laminating adhesives at a simulated speed of 500 ft/min using an accurately adjustable doctor blade to ensure precise delivery of a 0.004±0.0002 inch (4±0.2 mils) adhesive film where the synthetic adhesive formulation is PVA at 57% solids (glue temperature=73° F.), and the bio-based adhesive formulations are ECOSPHERE at 39% and 49% solids (glue temperature=100° F.).

FIG. 6B is a graph plotting pin adhesion as a function of time for a plurality of adhesives at a plurality of wet film thicknesses used on a substrate having a C-Flute profile in a laminating system. In particular, FIG. 6B shows the effect of film thickness on laminating performance for two commercial adhesives at a simulated speed of 500 ft/min using an accurately adjustable doctor blade to ensure precise delivery of a 0.004±0.0002 inch (4±0.2 mils) adhesive film where the synthetic adhesive formulation is PVA at 52% solids (glue temperature=73° F.), and the bio-based adhesive formulation is ECOSPHERE at 49% solids (glue temperature=100° F.).

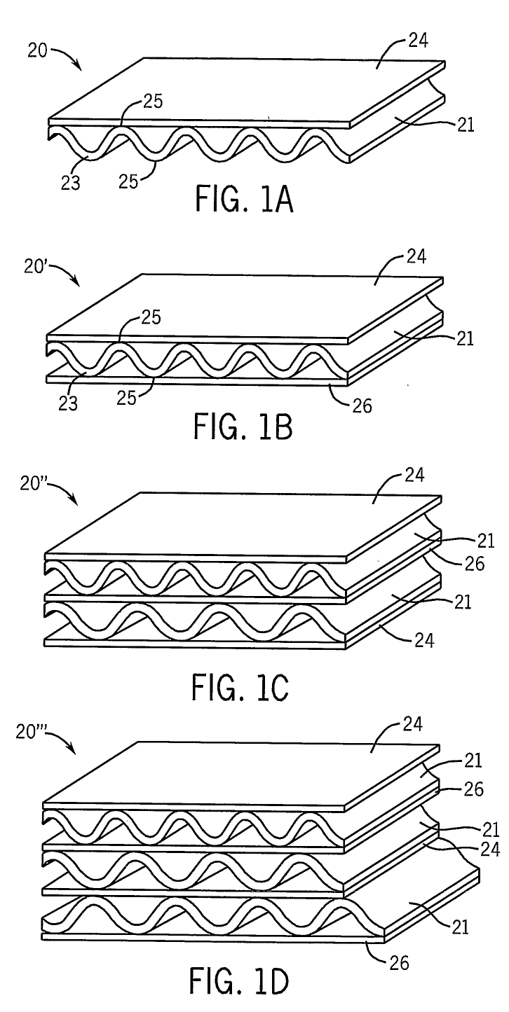

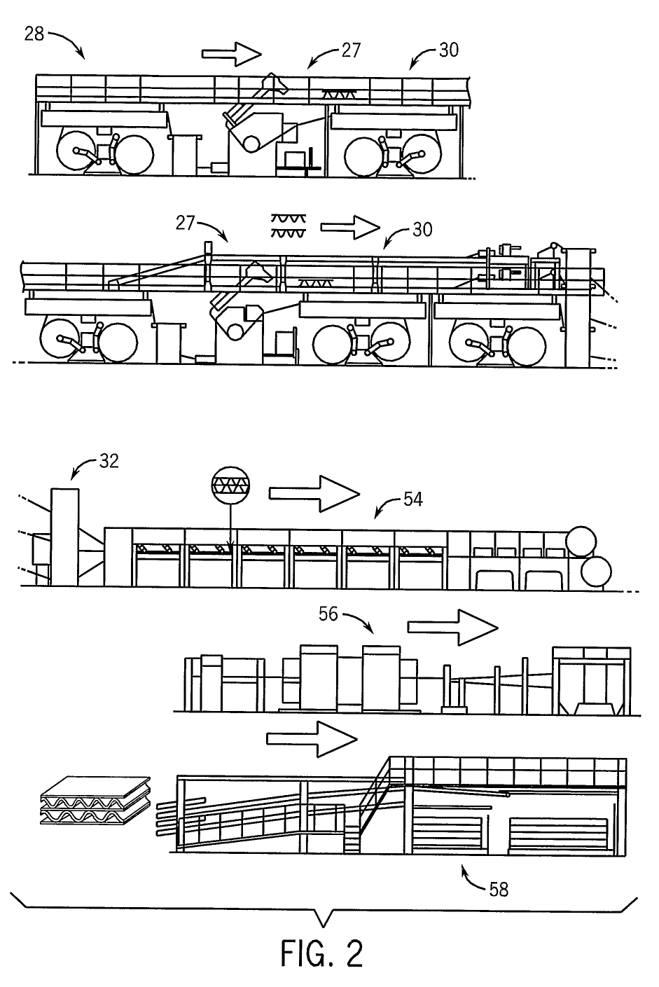

Like reference numerals will be used to refer to like parts from Figure to Figure in the following description of the drawings.

### DETAILED DESCRIPTION OF THE INVENTION

The present invention provides a method and apparatus for applying water-based adhesives to produce corrugated and laminated board products using less adhesive than traditionally possible. As described herein, the term “water-based adhesives” includes, but is not limited to: (1) water-soluble adhesives, such as polyvinyl alcohol and formulations based thereon, dextrins and formulations based thereon, and formulations of other water soluble polymers; (2) water based colloidal dispersions, such as biopolymer nanoparticles and formulations based thereon, polyvinyl acetate and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and formulations of other water based colloidal polymers; and (3) blends of any of the former.

U.S. Pat. No. 6,667,386, issued Jan. 13, 2004, describes a process for preparing biopolymer nanoparticles using an extrusion process wherein the biopolymer, for example starch or a starch derivative or mixtures thereof, is processed under high shear forces in the presence of a cross-linking agent. This patent also describes starch nanoparticles, aqueous dispersions of said nanoparticles, and an extrudate prepared by the process that swells in an aqueous medium and forms a low viscous colloidal dispersion after immersion. This patent is incorporated herein by reference along with all other publications cited herein.

The starch particles are described as having a narrow particle size distribution with particle sizes below 400 nm (=0.016 mil), and especially below 200 nm. In comparison with a conventional starch corrugating adhesive, they are further characterized by the absence of a gel point, and their lower viscosity at higher solids. Many applications are mentioned for use of the starch nanoparticles, including as a component for adhesives. However, no examples are provided to demonstrate the adhesive characteristics of the particles nor are any specific adhesive application systems mentioned.

### Corrugating Process

As described above, a higher solids colloidal adhesive has a number of advantages, including process and product quality advantages as well as significant energy savings due to the lower water content and the absence of a gel point. However, given the limitations of the conventional available adhesive application equipment in the industry and given the higher cost of such adhesives (even on a dry basis), implementing a higher solids colloidal adhesive presents a significant challenge from an economic perspective. For example, it is difficult to justify the additional adhesive cost if approximately the same wet film thickness is applied for a 44% solids colloidal polymer as for a conventional 22% solids corrugating adhesive. In that case, the amount applied for the polymer colloid is twice that of the conventional adhesive on a dry basis. Therefore, it is desirable to be able to closely control adhesive application for such higher solids adhesives.

Even if the rate of adhesive application can be controlled, the hurdle of switching to a more environmentally preferred high solids adhesive must be borne out by an improvement in product quality, process operation and/or energy cost. Though complete re-design of adhesive application equipment might be an approach to solving this issue, given the cost-sensitive nature of the corrugating industry it makes a lot of sense to implement several innovative design changes to the existing equipment.

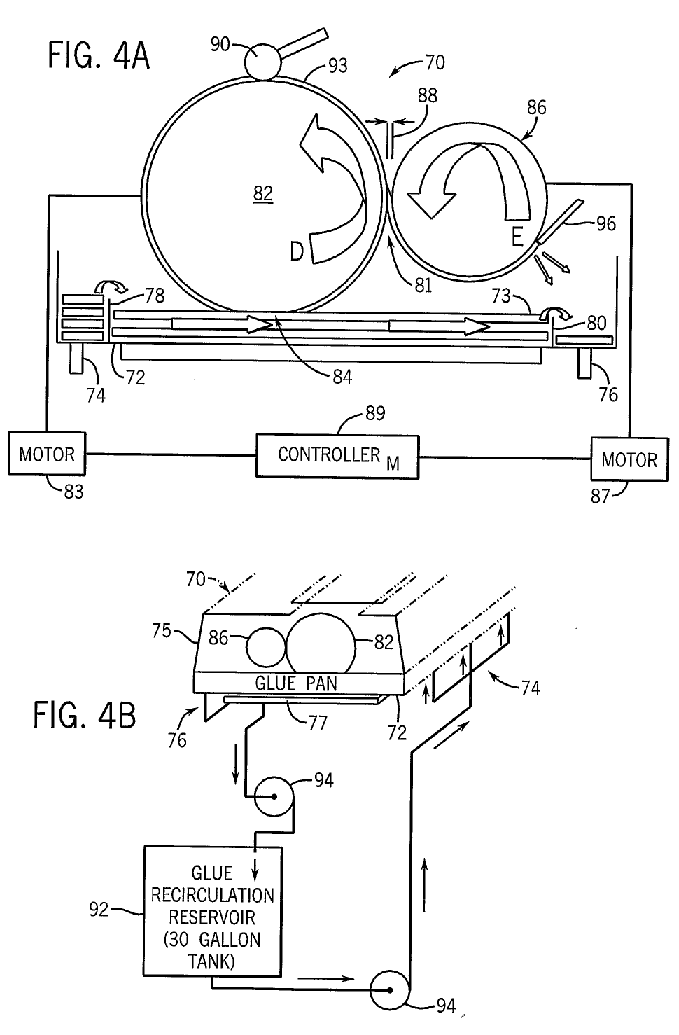

Referring now to FIG. 4A, a glue station 70 (such as a double facer glue station) constructed in accordance with certain aspects of the present invention includes several elements that, both alone and in combination, contribute to the reduction of adhesive application on the double facer glue machine in corrugating, thus improving the overall process and board quality. Specifically, glue station 70 provides precise control for the delivery of high solids and high viscosity adhesives, and thus avoids the warping and shrinkage that is experienced with conventional corrugating systems.

Glue station 70 includes a glue pan 72 that receives liquid adhesive 73 via a plurality of large glue inlet manifolds 74, and delivers excess adhesive to a plurality of large glue outlets 76 which, for example, are 1½ to 2½ times larger than the conventional inlets and outlets (for instance, at least 3 inches in diameter). The glue inlet manifolds 74 and glue outlets 76 are separated from the glue pan 72 via an inlet weir 78 and an outlet weir 80, respectively. Advantageously, the height of weirs 78 and 80 are optimally designed in order to control the height of adhesive in the glue pan 72 (as illustrated, the inlet weir 78 is maintained at a greater height than that of the outlet weir 80, which is designed to be just high enough for the applicator roll to pick up the adhesive liquid, but not too high so as to cause flooding of the nip).

A glue applicator roll 82 includes a lower portion 84 that receives adhesive 73 from the glue pan 72. Applicator roll 82 rotates in the direction indicated by Arrow D. A metering roll 86 rotates in the direction of Arrow E (in the same direction as applicator roll 82) in close proximity to the applicator roll 82. A gap 88 separates the rolls 82 and 86, and determines the thickness of adhesive remaining on the portion of applicator roll 82 that has traveled past metering roll 86. Under normal operation, a pressure bar would bias a substrate (e.g., a single face) against roll 86 in the manner described above. However, in the embodiment illustrated in FIG. 4A, the pressure bar has been replaced by an adhesive thickness gauge 90 that was used, for the purposes of the Examples below, to determine the thickness of the adhesive layer 93 disposed on applicator roll 82. It will be appreciated that a similar thickness gauge was used to determine adhesive thicknesses using the conventional glue station 32.

In accordance with certain aspects of the present invention, the applicator roll 82 and metering roll 86 have a reduced surface energy with respect to rolls of conventional systems. The present inventors have determined that the reduced surface energy facilitates thinner adhesive films when using high viscosity (approximately 1000 to 3000 cps) adhesives. The reduced surface energy is achieved by producing rolls whose outer surfaces are engraved with a pattern of less than 20 lines per inch, which has assisted in facilitating the use of high viscosity adhesives (approximately 1000-300 cps) while, at the same time, producing an adhesive layer on applicator roll 82 at a location downstream from gap 88.

As illustrated, the applicator roll 82 and metering roll 86 are independently controlled by motors 83 and 87, respectively, whose speed can each be independently controlled by a controller 89, for example, a digital drive in combination with an encoder to ensure that applicator roll 82 can be tuned to run at approximately a 1:1 ratio with respect to the speed of single face web 20. Alternatively, a pair of controllers 89 could be used for the corresponding pair of motors 83 and 87.

In accordance with certain aspects of the invention, the speed of metering roll 86 rotation is controlled to between 100% and 120% the speed of applicator roll 82 rotation. Without being limited by theory, the present inventors have discovered that the increased speed ratio (compared to conventional systems) increases the shear rate in the nip region 81 (located at the void between the lower portions of application roll 82 and metering roll 86) to result in a reduced viscosity of the adhesive and as a result a lower wet adhesive thickness on the application roll 82 at a location downstream of gap 88.

Referring also to FIG. 4B, the adhesive 73 disposed in glue pan 72 is circulated through a glue recirculation reservoir 92 that is connected to the glue pan inlets 74 and outlets 76 via a pair of diaphragm pumps 94. Reservoir 92 was constructed as a 30 gallon tank, however one skilled in the art will appreciate that reservoir 92 could be constructed of any suitable size. Pumps 94 are advantageously configured to induce the adhesive disposed in the glue pan 72 to flow in the direction from inlet 74 to outlet 76, parallel to direction of movement of the lower portion 84 of applicator roll 82.

One or more heating pads 77, disposed at the base of the pan 72, deliver heat to adhesive 73 and to control it at 110° F.±5° F. during testing. This type of heating was practical for the applicator-roll study conducted as part of Example 1. It may not be required in commercial corrugators that supply the adhesive from a large volume storage vessel (typically about 1000 gallons) of glue prepared in the starch kitchen. However, some heating may be required if a smaller starch kitchen is used, or in the event a satellite tank is utilized in close proximity to the glue application system. As will be described in more detail below, the glue pan 72 has been designed to facilitate implementation of high solids (i.e., high viscosity) adhesives.

A cover 75, formed from Plexiglas™, encapsulated glue station to prevent the adhesive 73 from prematurely drying during testing, it being appreciated that a glue station would not include cover 75 during normal operation.

A blade 96 scrapes excess adhesive off the metering roll 86, such that the scraped adhesive falls under gravitational force into glue pan 72. The applicator roll 82 then delivers the adhesive to the flute tips of the single face web (not shown) as it travels across the upper surface of the applicator roll 82 at a location downstream of the gap 88.

The construction of glue pan 72, including height-adjustable weirs 78 and 80, along with the direction of adhesive flow through pan 72, prevents the adhesive disposed in glue pan 72 from flooding the nip region 81 prior to the adhesive entering gap 88. Accordingly, the thickness of the wet adhesive on applicator roll 82 at a location downstream of gap 88 (adhesive that is subsequently applied to the single face) can be optimized to be less than the thickness of gap 88. This was previously not attainable when attempting to utilize a high viscosity adhesive in a conventional glue station.

Advantageously, glue station 70 is constructed as a modification to existing conventional glue stations, such as glue station 32 described above. Accordingly, the principles of the present invention can be implemented through the modification of conventional glue stations, thus conserving cost and other related inefficiencies that would arise from the complete replacement of existing equipment.

An alternative embodiment of the present invention is illustrated in FIG. 4C which depicts the glue station 70′ similar to glue station 70 described above, with the modification of replacing metering roll 86 with a scraper blade 86 supported by a housing 91. Blade 86 is configured to oscillate in a horizontal direction parallel to the outer glue-adhering surface of applicator roll 82. Blade 86 is placed a predetermined distance from applicator roll 82 to produce gap 88 between blade 86 and roll 82, and scrapes excess adhesive having a thickness greater than the thickness of gap 88. The excess adhesive then falls under gravitational force into glue pan 72. The distance between roll 82 and scraper blade 86, along with the frequency of oscillation, can be controlled via motor 87 and corresponding controller 89.

The above-described glue stations 70 illustrated in FIGS. 4B and 4C enable a water-based adhesive to be applied onto the flute tips of single face web at a wet solids level up to 72% (wt/wt) to produce an applied dry solids coat weight of less than 1.2 lbs/msf C-flute equivalent for the layer of double facer glue lines of a single wall board construction (it being appreciated that multiple wall corrugated boards can also be produced using the principles of the present invention).

### Laminating Process

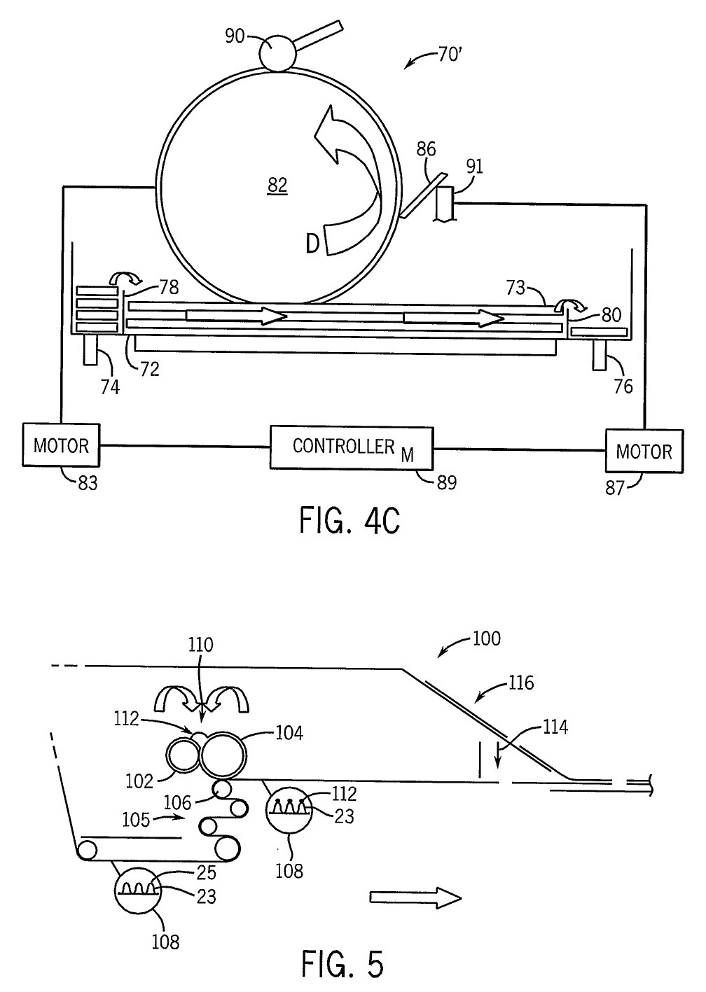

Referring now to FIG. 5, an in-line laminator 100 includes a metering roll 102 and an applicator roll 104 as described above. Typically, the applicator roll 104 is driven by a belt and pulley system (not shown), via the main drive motor (not shown) of the laminating section itself. The metering roll 102 is driven by a constant speed motor at a relatively low speed (generally about 7.5 fpm), and accordingly acts as a moving scraper blade.

A plurality of drive rolls 105 receives a substrate 108 (which can be a single face), and feeds the substrate 108 along the lower surface of applicator roll 104. Specifically, a rider roll 106 forces substrate 108 into contact with applicator roll 104. A liquid adhesive 112 is delivered to the nip region 110 (located above the interface between rolls 102 and 104). Because laminator 100 essentially forces a “flooding of the nip” scenario, the film thickness of adhesive 112 on applicator roll 104 generally exceeds that of the gap between the applicator roll 104 and the metering roll 102. Unlike corrugators, laminator 100 does not include a glue pan.

During operation, the adhesive 112 collects on the outer surface of the applicator roll 104, and is delivered to the tips of the fluted substrate 108 that travels in the same direction as the portion of roll 102 that interfaces with the substrate 108. The substrate 108 can then be cut as desired by a knife 114 located downstream from applicator roll 104. A sheet of pre-cut (and often colored or pre-printed) liner 116 is then applied to the glued outer surface (flute tips) 25 of substrate. In addition to using pre-cut liners, most in-line laminators can also be configured to apply a continuous liner that is cut after being adhered to the single face web. This is commonly referred to as “roll-to-roll” in-line laminating.

In conventional laminators, the applicator roll 104 is designed to run as close as possible to the speed of substrate 108. However, in practice the applicator roll 104 typically runs above or below the speed of substrate, which increases the amount of adhesive 112 applied. This is because the drive system (commonly vacuum belts or drive rolls) that pulls the paper typically runs faster than the paper speed, which generally causes differing levels of slippage as a result of the many different paper grades used, due to glue (or other) contamination of the belts, age of the belts, etc. It is also important to note that the speed indicator (i.e., motor speed, belt speed, etc.) is from a secondary source that only approximates the speed of the single face web. Once the adhesive 112 has been applied, the substrate 108 can then be cut and lined with a liner, as illustrated (as noted, there are a number of different processes in addition to in-line laminating, which laminate liners, mediums, labels, sheets of corrugated board, etc.).

At present, the adhesive application on a number of different types of commercial laminating processes is generally heavy. For instance, the adhesive application on in-line laminators (which is typically for single wall board only) at the double facer section is much heavier than in corrugating. It ranges from about 2 to 6 lb/msf of dry adhesive, due to the design of the glue application system.

Certain aspects of the present invention reduce the amount of required adhesive application in laminating, and thus improve the overall process and board quality (reduced warp, shrinkage, etc.):

For instance, a digital drive (as opposed to a conventional analog drive) in combination with an encoder ensures that the surface of the applicator roll 104 (or layer of adhesive 112) that interfaces with substrate 108 can be tuned to run at a ratio of approximately 1:1 with respect to the speed of substrate 108.

Furthermore, the height of the upper rider roll 106 can be adjusted via a controller (not shown) to ensure that the flute tips 25 of flutes 23 dip only into a fraction of the wet adhesive film (for instance, the rider roll 106 can be controlled such that flutes 23 actually touch the applicator roll 104). Normally, the height of the rider roll 106 is set to one specific setting for each flute size to accommodate for the difference in caliper.

Additionally, as described above with respect to glue station 70, the speed of rolls 102 and 104 are independently controlled, and the metering roll 102 is maintained at a level between 100% and 120% of the speed of the applicator roll 104 to obtain a reduced wet film thickness on applicator roll 104 with respect to conventional laminators.

Finally, as discussed above with respect to glue station 70, metering roll 102 can be replaced with an adjustable oscillating scraper blade (not shown) to meter the amount of adhesive 112 on roll 102. Excess scraped glue then falls into a catch pan that is connected to the drain.

Laminator 100 thus enables a water-based adhesive at a wet solids level up to 72% (wt/wt) to be applied either to the flute tips of a single face medium, to one or more liners, to one or more mediums, to labels, or to the outside liner of one or more combined corrugated board sheets, to result in an applied dry solids coat weight of less than 2.0 lb/msf per applied adhesive layer.

The enhanced operation of laminator 100 represents significant savings in adhesive consumption and as a result significantly improves board quality by reducing warp and in-process curing time between production of laminated board and subsequent operations.

The following examples illustrate the effects of certain aspects of the present invention on corrugating and laminating processes, it being appreciated that the following examples are merely illustrative, and not intended to limit the scope of the present invention.

### EXAMPLES

### Example 1

As discussed above, certain aspects of the present invention apply a high solid (for example, between 35 and 72% solids on a “bone dry” basis) adhesive with glue station 70. However, because of the higher solids than what is traditionally used, and because the viscosity of such higher solids adhesives is generally higher than that of the traditional corrugating glues, an excessive amount of the adhesive would be applied to the single face using conventional glue stations due to flooding of the nip.

In order to determine the effectiveness of glue station 70 using a high viscosity adhesive, the rotational speed of the glue applicator roll 82 and the metering roll 86 were independently controlled in the manner described above. In accordance with one aspect of the invention, the metering roll 86 to applicator roll 82 speed ratio can vary between 25% and 200% at speeds ranging from 250 ft/min to 1100 ft/min. A control panel (not shown) was installed to provide an interface with controller 89 for the purposes of controlling the speeds of rolls 82 and 86 and the gap setting 88. The control panel further displayed the two speeds, the metering roll position, and the metering to applicator roll speed ratio.

The applicator roll 82 was refinished and engraved with 4 equally sized quadrants at 45, 35, 25 and 17 lines per inch (LPI); the TIR of the roll 82 was ±0.0005 inch. The glue pan was controlled at 100° F.±5° F. using a pair of heating pads 77. As a result, the rolls were at approximately the same temperature. The entire glue station 70 was covered with removable Plexiglas covers to reduce evaporation of water, yet to facilitate wet film thickness measurements; solids analysis proved that the change in % solids over the duration of the experiments were less than 1%. The gap 88 was set to 0.004 inch and verified using feeler gauges.

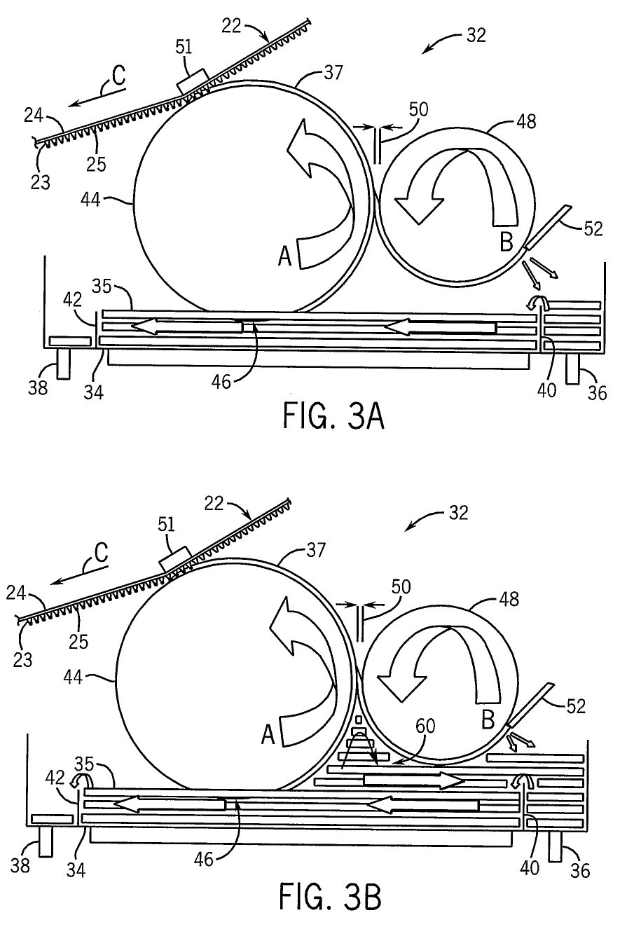

A first trial was conducted using a conventional glue station (such as station 32 illustrated in FIG. 3B) using a commercial starch corrugating adhesive at 22% solid content, and several high solids adhesive formulations based on colloidal biopolymer nanospheres, ranging from 40 to 48% solids. Flooding of the nip 60 was minimal for the conventional starch adhesive at 22% solids as well as for the colloidal biopolymer adhesive at 40-42% solids. These adhesives had a similar viscosity of ˜300-500 cps, but due to their different rheological characteristics the use of conventional glue stations with such high solids adhesive at 40-42% solids is impractical. The design of the existing glue applicator systems therefore needs to be improved so that the important advantages of high solids adhesives can be realized. Severe flooding of the nip was observed for formulations of the colloidal biopolymer at 45-48% solids which had relatively higher viscosity (˜1500-2500 cps). This was confirmed by removing the side panel cover of the rolls 44 and 48, and observing flooding of the nip region 60. A wet film thickness was measured ranging from about 8-12 mils (with some variance depending on the quadrant, roll speed and roll speed ratio). The trial was temporarily suspended, and different glue pan designs were investigated. FIG. 3B illustrates a glue pan design in which flooding of the nip is exacerbated.

The trial was then repeated using glue station 70 (FIG. 4A) as described above. The performance of the high solids adhesive using glue station 70 was superior to that using conventional glue station 32, as the wet film thickness on roll 82 was reduced to as low as 0.0025 inch. Table 1 summarizes certain findings with respect to two formulations of colloidal biopolymer nanospheres at 45 and 48% solids (film thickness readings were measured with a WF-2114 Gardco IC gauge, 2-12 mils (50-300) μm and are based on the average of triplicate measurements; applicator roll speed, Vₐ=600 fpm; the speed of the metering roll, Vₘ, is expressed as the ratio with the applicator roll, Vₘ/Vₐ; gap=0.004 inch).

TABLE 1
Wet Film Thickness Results For Applicator-Roll
Study Using The New Glue Pan Design

| % Solids | % Vₘ/Vₐ | 45 LPI | 35 LPI | 25 LPI | 17 LPI |
|---|---|---|---|---|---|
| 45 | 10 | 7.0 | 6.0 | 5.0 | 5.0 |
| 45 | 25 | 7.0 | 4.5 | 5.0 | 4.5 |
| 45 | 50 | 6.0 | 4.0 | 4.0 | 3.0 |
| 45 | 75 | 6.0 | 4.0 | 4.0 | 3.5 |
| 45 | 85 | 6.0 | 4.0 | 4.0 | 4.0 |
| 45 | 100 | 6.5 | 4.0 | 4.0 | 3.0 |
| 45 | 120 | 6.5 | 4.0 | 4.0 | 3.0 |
| 48 | 10 | 7.0 | 5.5 | 5.5 | 5.5 |
| 48 | 25 | 6.0 | 4.5 | 4.5 | 3.5 |
| 48 | 50 | 5.5 | 4.0 | 4.5 | 3.0 |
| 48 | 75 | 6.5 | 3.5 | 4.0 | 3.0 |
| 48 | 85 | 5.0 | 4.0 | 4.0 | 3.0 |
| 48 | 100 | 4.5 | 3.5 | 3.5 | 3.0 |
| 48 | 120 | 6.0 | 3.5 | 4.0 | 2.5 |

Table 1 shows that the film thickness is reduced by increasing the speed ratio of metering roll 86 to applicator roll 82 to a level between 100-120%, and further by decreasing the surface energy of the rolls to less than 20 LPI. The lowest film thickness was observed for 120% at 17 LPI, whereas the general industry trend has been to move to higher surface energy rolls for its much lower viscosity corrugating adhesives in order to prevent slinging.

These results were then confirmed on a commercial corrugator. Its glue roll was resurfaced to 20 LPI, and the flow of the adhesive through the pan was adjusted so it flowed in an unrestricted manner. The total run-out (TIR) of the rolls as well as the alignment and the bearings were checked to ensure the glue gap was as accurate as possible.

TABLE 2
Verification Of The Wet Film Thickness Results Of The
Applicator-Roll Study On A Commercial Corrugator

| Machine | Gap Setpoint | | | |
|---|---|---|---|---|
| Speed | (inches) | Drive Side | Middle | Operator Side |
| 600 | 0.004 | 2.0 | 2.5 | 2.5 |
| | 0.005 | 2.0 | 3.4 | 3.4 |
| | 0.006 | 4.5 | 3.5 | 6.0 |

The results in Table 2 are consistent with the data in Table 1. The results show that there was a minor alignment problem on the drive side of the commercial glue application system.

Therefore, the design of glue pan 72 substantially contributes to the ability to implement high solids adhesives during the corrugating process. Furthermore, by using the glue pan 72 design, flooding of the nip was eliminated.

Separately, when controller 89 is equipped with a digital drive, instead of analog drives, with an encoder on the board, the applicator roll drive 83 can be tuned to run at a 1:1 ratio with respect to the speed of single face web 20, resulting in greater reduction of adhesive application and further improving board quality (e.g., reduction of warping).

### Example 2

A pilot double facer corrugating facility was used to investigate the optimum glue application system for several formulations of colloidal biopolymer nanospheres. The equipment used rolls of 1 ft wide single face and liner board. These were preheated, and in-line IR sensors recorded the actual paper temperatures. The adhesive was applied on a scaled down applicator roll device similar in design to commercial glue machine 32. It was equipped with two accurate micrometers to control the glue gap, and because of its much smaller size, the gap could be controlled down to 1 mil (0.001 inch), and the resultant wet film thickness could readily be verified. The temperatures and the glue consumption were displayed and recorded on a computer. The glue consumption was measured by monitoring the weight of a 3 gallon glue recirculation reservoir that was connected to the glue pan. The glue was constantly pumped through the pan and the reservoir, and was kept at 110° F.±5° F. Based on the % solids of the adhesive formulation, this continuous weight measurement was converted to dry adhesive applied and recorded on the computer along with all of the other operating variables. A series of trials were performed, and the results are shown in Table 3. In a PIN adhesion test (see Table 3), a specified set of pins are inserted into the flutes of a test strip of combined board with specific dimensions, and the average force required to fracture the test strip is recorded. A set of 5 test strips was tested for each condition, and the average PIN value is reported (TAPPI Test Method T821).

TABLE 3
Pilot corrugating results for a formulation of biopolymer nanospheres

| | Line | Glue | Temperature | | | | | | | | Glue | Pin |
|---|---|---|---|---|---|---|---|---|---|---|---|---|
| | Speed | Temp | Liner | SF | Plate Temp (F.) | | | | | | Deposit | Adhesion |
| Trial | ft/min | ° F. | Act | Act | SP | Act | SP | Act | SP | Act | lb/msf | lbf |
| 1 | 330 | 110 | 178 | 169 | 248 | 163 | 248 | 120 | 248 | 196 | 1.23 | 56 ± 5.2 |
| 2 | 330 | 109 | 180 | 176 | 248 | 165 | 248 | 106 | 248 | 194 | 1.23 | 57 ± 1.3 |
| 3 | 330 | 109 | 180 | 172 | 248 | 165 | 248 | 122 | 248 | 196 | 1.23 | 57 ± 4.7 |
| 4 | 330 | 110 | 169 | 176 | 248 | 156 | 248 | 113 | 248 | 194 | 1.20 | 57 ± 2.9 |
| 5 | 330 | 111 | 185 | 172 | 248 | 174 | 248 | 122 | 248 | 199 | 0.92 | 50 ± 1.6 |
| 6 | 660 | 109 | 154 | 176 | 248 | 153 | 248 | 126 | 248 | 192 | 0.68 | 51 ± 3.1 |
| 7 | 660 | 109 | 154 | 176 | 248 | 153 | 248 | 126 | 248 | 192 | 0.68 | 54 ± 2.5 |
| 8 | 660 | 109 | 154 | 176 | 248 | 153 | 248 | 126 | 248 | 192 | 0.68 | 51 ± 0.4 |
| 9 | 660 | 111 | 153 | 172 | 248 | 160 | 248 | 120 | 248 | 194 | 1.54 | 60 ± 2.7 |
| 10 | 660 | 109 | 169 | 176 | 248 | 154 | 248 | 113 | 248 | 190 | 1.15 | 54 ± 2.0 |
| 11 | 330 | 111 | 162 | 165 | 176 | 133 | 176 | 100 | 176 | 149 | 1.23 | 58 ± 1.6 |
| 12 | 330 | 111 | 158 | 171 | 176 | 135 | 176 | 100 | 176 | 149 | 1.06 | 53 ± 2.0 |
| 13 | 660 | 109 | 158 | 176 | 176 | — | 176 | — | 176 | — | 1.23 | 56 ± 1.6 |

The PIN adhesion value indicates the bond strength of the corrugated sheet. Corrugated box plants would typically reject board below a PIN value of 40, while a value of >50 generally ensures complete fiber tear. The target glue application rate for most commercial corrugators is 1.2 to 2.0 lb/msf C-flute equivalent for single wall board on a dry basis. The results in Table 3 demonstrate that it is possible to obtain good adhesion for a dry adhesive application rate of less than 1.2 lb/msf. The design benefits of the glue application system of the present invention are critical to the application of high solids water-based adhesives in commercial corrugating operations.

It should be appreciated that the very low hot plate temperatures in Table 3 would not be feasible for a conventional starch corrugating adhesive, and therefore these results further demonstrate the importance of an application system which can deliver low wet film thicknesses for high solids adhesives. As a result, the potential benefits include improved productivity and reduced warp, shrinkage, adhesive consumption, energy consumption, and overall cost of manufacturing.

### Example 3

To illustrate the need to re-design conventional commercial laminators, two commercial laminating adhesives were used, which included formulations of synthetic adhesive formulations based on polyvinyl acetate (PVA), and bio-based adhesive formulations based on biopolymer nanospheres (ECOSPHERE). Both types of adhesive formulations contain colloidal dispersions, while the former is derived from petroleum based resources and the latter is derived from agricultural resources. The particle size of biopolymer nanoparticles generally is significantly smaller than that of the synthetic adhesive.

The pilot testing equipment used a 2 inch wide strip of single face that was preheated to 110° F.±5° F. to simulate the temperature of the board coming from the single facer to the double facer of a commercial in-line laminator. The single face strip was transported mechanically at a specified speed across a glue roll positioned on a temperature-controlled glue reservoir. PVA was supplied in liquid form and tested as is at room temperature (73° F.), and ECOSPHERE was supplied in dry form and was first dispersed and then tested at 100F.

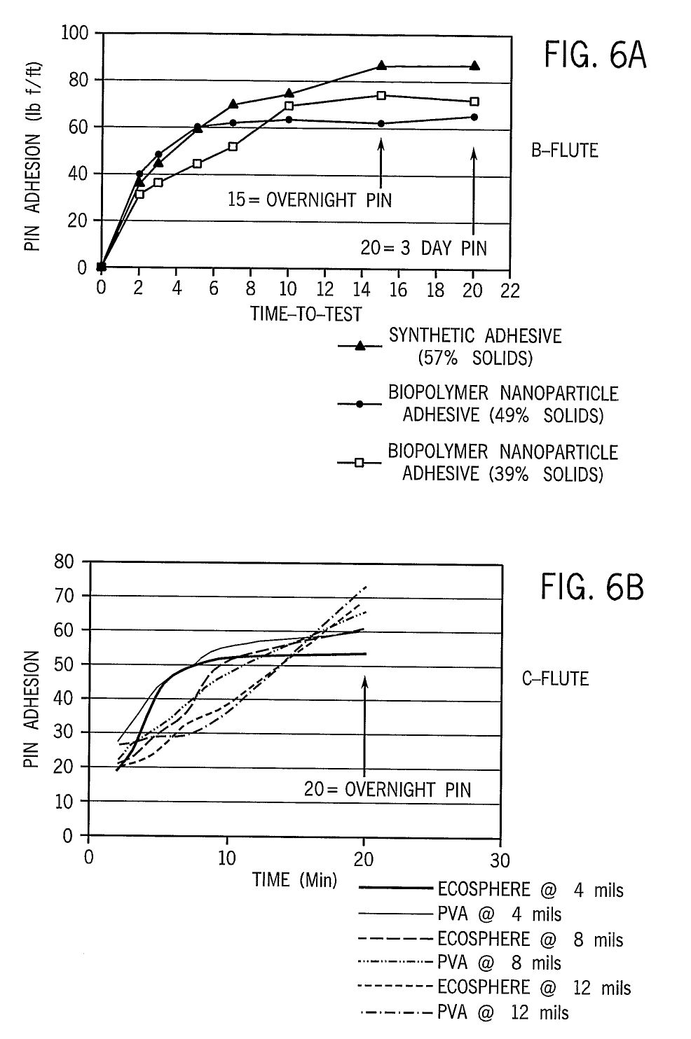

The glue roll was equipped with an accurately adjustable doctor blade to ensure precise delivery of a thin adhesive layer onto the flute tips (for example, a 0.004±0.0002 inch adhesive film was used for the pilot tests in FIG. 6A). In an uninterrupted sequence, the single face strip containing the adhesive on its flute tips was then transported onto a liner running at the same speed.

The combined board was subsequently held in a press section at ambient temperatures for a specified time. The pressure and time in the press section were pre-calculated and set to simulate the pressure and speed of a commercial in-line laminator given the length of the two press sections that are typical for the commercial operation. The “green” adhesive bond strength was then immediately tested at specific times from the point of adhesive application using a PIN adhesion tester (with pin testing modules designed for the specific C and B flutes used), to determine the development of adhesive bond strength with time. “Green Bond” is a subjective measurement of the curing rate of the adhesive. It is measured by the machine foreman or other designated member of the crew, and is “judged” by the appearance of the early bond on the machine (i.e. green bond), when manually pulling the board apart as it is delivered from the double facer or the single facer. At this point of the process, the bond is not sufficiently set to obtain the high “Pin Adhesion” values that may be required to meet the manufacturing spec (typically >45) and to make high quality boxes.

Commercial in-line laminators typically run at speeds of up to about 600 ft/min. The results in FIG. 6A show the rate of adhesive strength built with time for the two types of laminating adhesives. Notably, the initial rate of adhesive strength built for the two high solids laminating adhesives is quite similar. This initial high PIN is important to enable the manufactured board to be processed through the in-line laminator at high speeds without delaminating in the press section of the process. As expected, the lower solids version at 39% solids shows a slower initial PIN adhesion build, and this would normally mean that this lower solids formulation would have to be processed at slower line speeds. The board then continues to cure in the stack to yield a product with acceptable strength. Note that both types of commercial laminating adhesives at all solids levels tested in FIGS. 6A and 6B reached ultimate PIN values well in excess of 50.

FIG. 6B illustrates that the rate of initial PIN built is lower for a higher wet film thickness for both adhesive types. This indicates that a thinner layer of adhesive is desirable for increased line speeds. This further indicates that the use of thin coating techniques, in combination with a lower solids adhesive, provides an effective way to further decrease the dry coat weight of adhesive applied in a lamination process.

These pilot laminating results correlated well with the performance of these synthetic and bio-based adhesives on commercial in-line laminators. Typically, higher wet film thicknesses (>0.0006″) were observed, unless at least one design change was implemented to the laminator adhesive application equipment in accordance with certain aspects of the present invention, as described above with reference to FIG. 5.

In view of the above, it will be seen that the several advantages of the invention are achieved and other advantageous results attained. As various changes could be made in the above processes and composites without departing from the scope of the invention, it is intended that all matter contained in the above description and shown in the accompanying drawings shall be interpreted as illustrative and not in a limiting sense.

### INDUSTRIAL APPLICABILITY

The invention relates to a method and an apparatus for applying water-based adhesives to produce corrugated and laminated board products.

1. A method of applying a water-based adhesive to a substrate in an apparatus including a metering device, an applicator roll receiving at its outer surface the water-based adhesive and delivering a layer of the water-based adhesive to the substrate, the method comprising:
applying the delivered layer at a coat weight less than 1.2 pounds/msf/layer based on dry weight per layer of adhesive applied.

2. The method as recited in claim 1 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

3. The method as recited in claim 2 wherein the biopolymer nanoparticles comprise particles of a cross-linked starch or a cross-linked starch derivative characterized by an average particle size of less than 400 nanometers.

4. The method as recited in claim 1 wherein the substrate is a fluted single face medium, and wherein the water-based adhesive is applied onto flute tips of the medium at a wet solids level up to 72% (wt/wt).

5. The method as recited in claim 1, wherein the apparatus further includes a glue pan that circulates the adhesive, and the method further comprises forcing the adhesive in the glue pan in a direction substantially parallel to a location on the applicator roll that receives the adhesive.

6. The method as recited in claim 5, wherein the metering device comprises a metering roll, and the method further comprises preventing the adhesive from pooling in a nip region disposed between the metering roll and the applicator roll.

7. The method as recited in claim 1, wherein the metering device comprises a metering roll, and the method further comprises rotating the metering roll at a speed between 100% and 120% of a speed at which the applicator roll is rotated.

8. The method as recited in claim 1, wherein the applicator roll is engraved with a pattern of less than 20 lines per inch.

9. The method as recited in claim 1 wherein the substrate travels at a speed between 98% and 102% of a speed of a portion of the applicator roll that interfaces with the substrate.

10. The method as recited in claim 1, wherein the layer has a thickness less than 0.005 inch.

11. The method as recited in claim 1, wherein the metering device comprises a scraper.

12. A glue station configured to apply a water-based adhesive to a substrate, the glue station comprising:
a rotating applicator roll for receiving the adhesive;
a metering device spaced from the applicator roll by a gap that meters the thickness of a layer of the adhesive on the applicator roll; and
a substrate delivery system for delivering the substrate to a location proximal the applicator roll,
wherein the substrate receives the layer in an amount less than 1.2 pounds/msf.

13. The glue station as recited in claim 12 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

14. The glue station as recited in claim 13, wherein the biopolymer nanoparticles comprise particles of a cross-linked starch or a cross-linked starch derivative characterized by an average particle size of less than 400 nanometers.

15. The glue station as recited in claim 12, wherein the substrate is a fluted single face medium, and wherein the water-based adhesive is applied onto flute tips of the medium at a wet solids level up to 72% (wt/wt).

16. The glue station as recited in claim 12, wherein the applicator roll receives a layer of the adhesive from a glue pan retaining the water-based adhesive.

17. The glue station as recited in claim 16, wherein the adhesive travels in the glue pan in a direction substantially parallel to a location on the applicator roll that receives the adhesive.

18. The glue station as recited in claim 12, wherein the metering device comprises a rotating metering roll.

19. The glue station as recited in claim 18, wherein the adhesive does not pool in a nip region disposed between the metering roll and the applicator roll.

20. The glue station as recited in claim 18, wherein the metering roll rotates at a speed substantially equal to between 100% and 120% of a speed at which the applicator roll is rotated.

21. The glue station as recited in claim 18, wherein the substrate travels at a speed between 98% and 102% of a speed of a portion of the applicator roll that interfaces with the substrate.

22. The glue station as recited in claim 12, wherein the applicator roll is engraved with a pattern of less than 20 lines per inch.

23. The glue station as recited in claim 12, wherein the adhesive layer has a thickness less than 0.005 inch.

24. The glue station as recited in claim 12, wherein the metering device comprises a scraper.

25. A corrugated board construction comprising:
a single face medium adhered to a liner by a water-based adhesive applied at a dry solids coat weight of less than 1.2 lb/msf C-flute equivalent per layer of double facer glue lines, the number of said layers being one for single wall board construction, two for double wall board construction, and three for triple wall board construction, and at a glue application rate proportional to the number of layers of double facer glue lines.

26. The corrugated board construction as recited in claim 25 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

27. The corrugated board construction as recited in claim 26, wherein the biopolymer nanoparticles comprise particles of a cross-linked starch or a cross-linked starch derivative characterized by an average particle size of less than 400 nanometers.

28. A method for producing laminated board, the method comprising:
applying a water-based adhesive at a dry solids coat weight of less than 2.0 lb/msf to the flute tips of a substrate comprising a single face medium.

29. A method for producing laminated board, the method comprising:
applying a water-based adhesive at a dry solids coat weight of less than 2.0 lb/msf to a substrate comprising one or more liners.

30. A method for producing laminated board, the method comprising:
applying a water-based adhesive at a dry solids coat weight of less than 2.0 lb/msf to a substrate comprising one or more mediums.

31. A method for producing laminated board, the method comprising:
applying a water-based adhesive at a dry solids coat weight of less than 2.0 lb/msf to a substrate comprising a liner of one or more combined corrugated boards.

32. A method for producing laminated board, the method comprising:
applying a water-based adhesive at a dry solids coat weight of less than 2.0 lb/msf to a substrate comprising a label.

33. The method as recited in claim 28 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

34. The method as recited in claim 33, wherein the biopolymer nanoparticles comprise particles of a cross-linked starch or a cross-linked starch derivative characterized by an average particle size of less than 400 nanometers.

35. The method as recited in claim 28, wherein the water-based adhesive is applied at a wet solids level up to 72% (wt/wt) to result in an applied dry solids coat weight of less than 1.2 lb/msf per applied adhesive layer.

36. The method as recited in claim 28, wherein the water-based adhesive is applied as a thin coating by avoiding a wiping action and ensuring that the substrate and a glue applicator roll are running at close to the same speeds.

37. The method as recited in claim 36 wherein the water-based adhesive is applied as a thin coating by maintaining the glue applicator roll to substrate speed ratio between 98 to 102%.

38. The method as recited in claim 28, wherein the water-based adhesive is applied as a thin coating by adjusting a metering roll to applicator roll speed ratio to obtain the lowest possible wet film thickness on the applicator roll.

39. The method as recited in claim 28, wherein the water-based adhesive is applied as a thin coating by replacing a metering roll with an adjustable scraper blade to meter the amount of adhesive on the roll.

40. The method as recited in claim 28, wherein the water-based adhesive is applied as a thin coating by adjusting the height of a rider roll to ensure that the flute tips dip only into a fraction of the wet adhesive film.

41. The method as recited in claim 28, wherein a coating less than 0.005 inch is applied.

42. A laminated board construction comprising:
a single face medium adhered to liner by a water-based adhesive applied at a dry solids coat weight of less than 2.0 lb/msf.

43. A laminated board construction comprising:
one or more liners adhered by a water-based adhesive applied at a dry solids coat weight of less than 2.0 lb/msf per applied layer of adhesive.

44. A laminated board construction comprising:
one or more mediums adhered by a water-based adhesive applied at a dry solids coat weight of less than 2.0 lb/msf per applied layer of adhesive.

45. A laminated board construction comprising:
one or more combined corrugated boards adhered by a water-based adhesive applied at a dry solids coat weight of less than 2.0 lb/msf per applied layer of adhesive.

46. A laminated board construction comprising:
one or more labels adhered by a water-based adhesive applied at a dry solids coat weight of less than 2.0 lb/msf per applied layer of adhesive.

47. The laminated board construction as recited in claim 42 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

48. The laminated board construction as recited in claim 47 wherein the biopolymer nanoparticles comprise particles of a cross-linked starch or a cross-linked starch derivative characterized by an average particle size of less than 400 nanometers.

49. The method as recited in claim 4, wherein an increase in the solids level of the water-based adhesive up to 72% (wt/wt) leads to a shortening of the curing time between production of the combined board and subsequent operations.

50. The method as recited in claim 4, wherein an increase in the solids level of the water-based adhesive up to 72% (wt/wt) leads to improved productivity and reduced warp, shrinkage, adhesive consumption, energy consumption, and overall cost of manufacturing.

51. The method as recited in claim 1, wherein the reduction in the amount of water-based adhesive applied leads to a shortening of the curing time between production of the combined board and subsequent operations.

52. The method as recited in claim 1, wherein the reduction in the amount of water-based adhesive applied leads to improved productivity and reduced warp, shrinkage, adhesive consumption, energy consumption, and overall cost of manufacturing.

53. The method as recited in claim 4, wherein the % solids of the water-based adhesive ranges from 35 to 40% in order to further decrease the dry coat weight of adhesive in the resultant product.

54. The method as recited in claim 4, wherein the % solids of the water-based adhesive is less than 50% in order to further decrease the dry coat weight of adhesive in the resultant product.

55. The method as recited in claim 29 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

56. The method as recited in claim 55, wherein the biopolymer nanoparticles comprise particles of a cross-linked starch or a cross-linked starch derivative characterized by an average particle size of less than 400 nanometers.

57. The method as recited in claim 29, wherein the water-based adhesive is applied at a wet solids level up to 72% (wt/wt) to result in an applied dry solids coat weight of less than 1.2 lb/msf per applied adhesive layer.

58. The method as recited in claim 29, wherein the water-based adhesive is applied as a thin coating by avoiding a wiping action and ensuring that the substrate and a glue applicator roll are running at close to the same speeds.

59. The method as recited in claim 58 wherein the water-based adhesive is applied as a thin coating by maintaining the glue applicator roll to substrate speed ratio between 98 to 102%.

60. The method as recited in claim 29, wherein the water-based adhesive is applied as a thin coating by adjusting a metering roll to applicator roll speed ratio to obtain the lowest possible wet film thickness on the applicator roll.

61. The method as recited in claim 29, wherein the water-based adhesive is applied as a thin coating by replacing a metering roll with an adjustable scraper blade to meter the amount of adhesive on the roll.

62. The method as recited in claim 29, wherein the water-based adhesive is applied as a thin coating by adjusting the height of a rider roll to ensure that the flute tips dip only into a fraction of the wet adhesive film.

63. The method as recited in claim 29, wherein a coating less than 0.005 inch is applied.

64. The method as recited in claim 29, wherein the % solids of the water-based adhesive is less than 50% in order to further decrease the dry coat weight of adhesive in the resultant product.

65. The method as recited in claim 30 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

66. The method as recited in claim 65, wherein the biopolymer nanoparticles comprise particles of a cross-linked starch or a cross-linked starch derivative characterized by an average particle size of less than 400 nanometers.

67. The method as recited in claim 30, wherein the water-based adhesive is applied at a wet solids level up to 72% (wt/wt) to result in an applied dry solids coat weight of less than 1.2 lb/msf per applied adhesive layer.

68. The method as recited in claim 30, wherein the water-based adhesive is applied as a thin coating by avoiding a wiping action and ensuring that the substrate and a glue applicator roll are running at close to the same speeds.

69. The method as recited in claim 68 wherein the water-based adhesive is applied as a thin coating by maintaining the glue applicator roll to substrate speed ratio between 98 to 102%.

70. The method as recited in claim 30, wherein the water-based adhesive is applied as a thin coating by adjusting a metering roll to applicator roll speed ratio to obtain the lowest possible wet film thickness on the applicator roll.

71. The method as recited in claim 30, wherein the water-based adhesive is applied as a thin coating by replacing a metering roll with an adjustable scraper blade to meter the amount of adhesive on the roll.

72. The method as recited in claim 30, wherein the water-based adhesive is applied as a thin coating by adjusting the height of a rider roll to ensure that the flute tips dip only into a fraction of the wet adhesive film.

73. The method as recited in claim 30, wherein a coating less than 0.005 inch is applied.

74. The method as recited in claim 30, wherein the % solids of the water-based adhesive is less than 50% in order to further decrease the dry coat weight of adhesive in the resultant product.

75. The method as recited in claim 31 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

76. The method as recited in claim 75, wherein the biopolymer nanoparticles comprise particles of a cross-linked starch or a cross-linked starch derivative characterized by an average particle size of less than 400 nanometers.

77. The method as recited in claim 31, wherein the water-based adhesive is applied at a wet solids level up to 72% (wt/wt) to result in an applied dry solids coat weight of less than 1.2 lb/msf per applied adhesive layer.

78. The method as recited in claim 31, wherein the water-based adhesive is applied as a thin coating by avoiding a wiping action and ensuring that the substrate and a glue applicator roll are running at close to the same speeds.

79. The method as recited in claim 78 wherein the water-based adhesive is applied as a thin coating by maintaining the glue applicator roll to substrate speed ratio between 98 to 102%.

80. The method as recited in claim 31, wherein the water-based adhesive is applied as a thin coating by adjusting a metering roll to applicator roll speed ratio to obtain the lowest possible wet film thickness on the applicator roll.

81. The method as recited in claim 31, wherein the water-based adhesive is applied as a thin coating by replacing a metering roll with an adjustable scraper blade to meter the amount of adhesive on the roll.

82. The method as recited in claim 31, wherein the water-based adhesive is applied as a thin coating by adjusting the height of a rider roll to ensure that the flute tips dip only into a fraction of the wet adhesive film.

83. The method as recited in claim 31, wherein a coating less than 0.005 inch is applied.

84. The method as recited in claim 31, wherein the % solids of the water-based adhesive is less than 50% in order to further decrease the dry coat weight of adhesive in the resultant product.

85. The method as recited in claim 32 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

86. The method as recited in claim 85, wherein the biopolymer nanoparticles comprise particles of a cross-linked starch or a cross-linked starch derivative characterized by an average particle size of less than 400 nanometers.

87. The method as recited in claim 32, wherein the water-based adhesive is applied at a wet solids level up to 72% (wt/wt) to result in an applied dry solids coat weight of less than 1.2 lb/msf per applied adhesive layer.

88. The method as recited in claim 32, wherein the water-based adhesive is applied as a thin coating by avoiding a wiping action and ensuring that the substrate and a glue applicator roll are running at close to the same speeds.

89. The method as recited in claim 88 wherein the water-based adhesive is applied as a thin coating by maintaining the glue applicator roll to substrate speed ratio between 98 to 102%.

90. The method as recited in claim 32, wherein the water-based adhesive is applied as a thin coating by adjusting a metering roll to applicator roll speed ratio to obtain the lowest possible wet film thickness on the applicator roll.

91. The method as recited in claim 32, wherein the water-based adhesive is applied as a thin coating by replacing a metering roll with an adjustable scraper blade to meter the amount of adhesive on the roll.

92. The method as recited in claim 32, wherein the water-based adhesive is applied as a thin coating by adjusting the height of a rider roll to ensure that the flute tips dip only into a fraction of the wet adhesive film.

93. The method as recited in claim 32, wherein a coating less than 0.005 inch is applied.

94. The method as recited in claim 32, wherein the % solids of the water-based adhesive is less than 50% in order to further decrease the dry coat weight of adhesive in the resultant product.

95. The laminated board construction as recited in claim 43 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

96. The laminated board construction as recited in claim 95 wherein the biopolymer nanoparticles comprise particles of a cross-linked starch or a cross-linked starch derivative characterized by an average particle size of less than 400 nanometers.

97. The laminated board construction as recited in claim 44 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

98. The laminated board construction as recited in claim 97 wherein the biopolymer nanoparticles comprise particles of a cross-linked starch or a cross-linked starch derivative characterized by an average particle size of less than 400 nanometers.

99. The laminated board construction as recited in claim 45 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

100. The laminated board construction as recited in claim 99 wherein the biopolymer nanoparticles comprise particles of a cross-linked starch or a cross-linked starch derivative characterized by an average particle size of less than 400 nanometers.

101. The laminated board construction as recited in claim 46 wherein the water-based adhesive is selected from the group consisting of biopolymer nanoparticles and formulations based thereon, polyvinyl acetate and formulations based thereon, polyvinyl alcohol and formulations based thereon, dextrins and formulations based thereon, polyacrylics and formulations based thereon, vinyl acetate-acrylic copolymers and formulations based thereon, ethylene-vinyl acetate copolymers and formulations based thereon, vinyl acetate-ethylene copolymers and formulations based thereon, and other adhesives of similar characteristics, and blends of any of the former.

102. The laminated board construction as recited in claim 101 wherein the biopolymer nanoparticles comprise particles of a cross-linked starch or a cross-linked starch derivative characterized by an average particle size of less than 400 nanometers.
